(19) United States
(12) Patent Application Publication
(10) Pub. No.: US 2015/0335000 A1
(43) Pub. Date: Nov. 26, 2015

(54) COLLAPSIBLE FISHING ROD AND PEDESTRIAN SUPPORT APPARATUS

(71) Applicant: Gerard Rudebeck, (US)

(72) Inventor: Gerard Rudebeck, Florissant, MO (US)

(21) Appl. No.: 14/717,826

(22) Filed: May 20, 2015

Related U.S. Application Data
(60) Provisional application No. 62/001,377, filed on May 21, 2014.

(51) Int. Cl. A01K 87/02; A45B 3/00; A45B 9/00; A01K 87/04

(52) U.S. Cl. CPC A01K 87/025; A01K 87/04; A45B 3/00; A45B 9/00

(57) ABSTRACT

A collapsible fishing rod and walking cane includes a base assembly comprising a plurality of tubular members foldably attached to one another for folding between a collapsed position in which the tubular members are arranged side-by-side and an elongate position in which the tubular members are arranged end-to-end. The proximal tubular member of the base assembly has a proximal handle portion. The distal tubular member of the base assembly has an open distal end. A telescoping end assembly includes a plurality of tubular members arranged concentrically for telescoping between a collapsed position and an elongate position. The proximal tubular member of the telescoping end assembly is secured in the open distal end of the distal tubular member of the base assembly such that the distal tubular member of the telescoping end assembly extends distally away from the base in the elongate position. A reel is secured to the base assembly.

### FIELD

Aspects of the present invention generally relate to pedestrian support apparatuses, such as walking canes. More particularly, aspects of the present invention relate to pedestrian support apparatuses that can also be used as fishing rods.

### BACKGROUND

In many circumstances, it is helpful for pedestrians to use support apparatuses to relieve their feet when walking. For example, elderly, disabled, and injured individuals often have difficulty carrying their own weight. Pedestrian support devices, such as walking canes, are used to aid such individuals by supporting their weight while walking. Similarly, hikers traveling long distances with heavy rucksacks often use pedestrian support devices, such as walking sticks, to bear a portion of the load supported by their feet. It is occasionally desirable to conceal and/or store pedestrian support devices, but due to their elongate shape it can be difficult to do so. Thus, certain exemplary pedestrian support devices are made to be collapsible.

Pedestrian support devices typically occupy a user's hand when in use. As a result, the user's ability to carry other items is adversely affected. In some cases, users wish to travel to an activity, such as fishing, using their pedestrian support device. However, fishing is an activity that requires equipment to be transported along with the user to the fishing site. The use of a pedestrian support device can hamper an individual's capacity to carry fishing equipment.

### SUMMARY

In one aspect, a collapsible fishing rod and pedestrian support apparatus comprises a base assembly comprising a plurality of tubular members foldably attached to one another for folding between a collapsed position in which the tubular members are arranged side-by-side and an elongate position in which the tubular members are arranged end-to-end. The plurality of tubular members of the base assembly comprises at least a proximal and a distal tubular member. The proximal tubular member of the base assembly comprises a proximal handle portion. The distal tubular member of the base assembly comprises an open distal end. A telescoping end assembly comprises a plurality of tubular members arranged concentrically for telescoping between a collapsed position in which distal ends of each of the tubular members are arranged generally adjacent one another and an elongate position in which the tubular members are arranged end-to-end. The plurality of tubular members of the telescoping end assembly comprises at least a proximal and a distal tubular member. The proximal tubular member of the telescoping end assembly is secured in the open distal end of the distal tubular member of the base assembly such that the distal tubular member of the telescoping end assembly extends distally away from the base in the elongate position. A reel is secured to the base assembly.

In another aspect, a method of making a collapsible fishing rod and pedestrian support apparatus comprises securing a proximal tubular member of a telescoping end assembly in an open distal end of a distal tubular member of a base assembly. The telescoping end assembly comprises a plurality of tubular members arranged concentrically for telescoping between a collapsed position in which distal ends of each of the tubular members are arranged generally adjacent one another and an elongate position in which the tubular members of the telescoping end assembly are arranged end-to-end. The base assembly comprises a plurality of tubular members foldably attached to one another for folding between a collapsed position in which the tubular members are arranged side-by-side and an elongate position in which the tubular members are arranged end-to-end. The plurality of tubular members of the base assembly comprises a proximal tubular member comprising a handle portion. A reel is secured to the proximal tubular member of the base assembly.

Other objects and features will be in part apparent and in part pointed out hereinafter.

### BRIEF DESCRIPTION OF THE DRAWINGS

FIG. 1 is a perspective of a dual-purpose apparatus in a fully collapsed position;

FIG. 2 is a perspective of the apparatus configured for use as a walking cane;

FIG. 3 is a perspective of the apparatus configured for use as a fishing rod; and

FIG. 4 is a perspective of a telescoping end assembly of the apparatus.

Corresponding reference characters indicate corresponding parts throughout the drawings.

### DETAILED DESCRIPTION

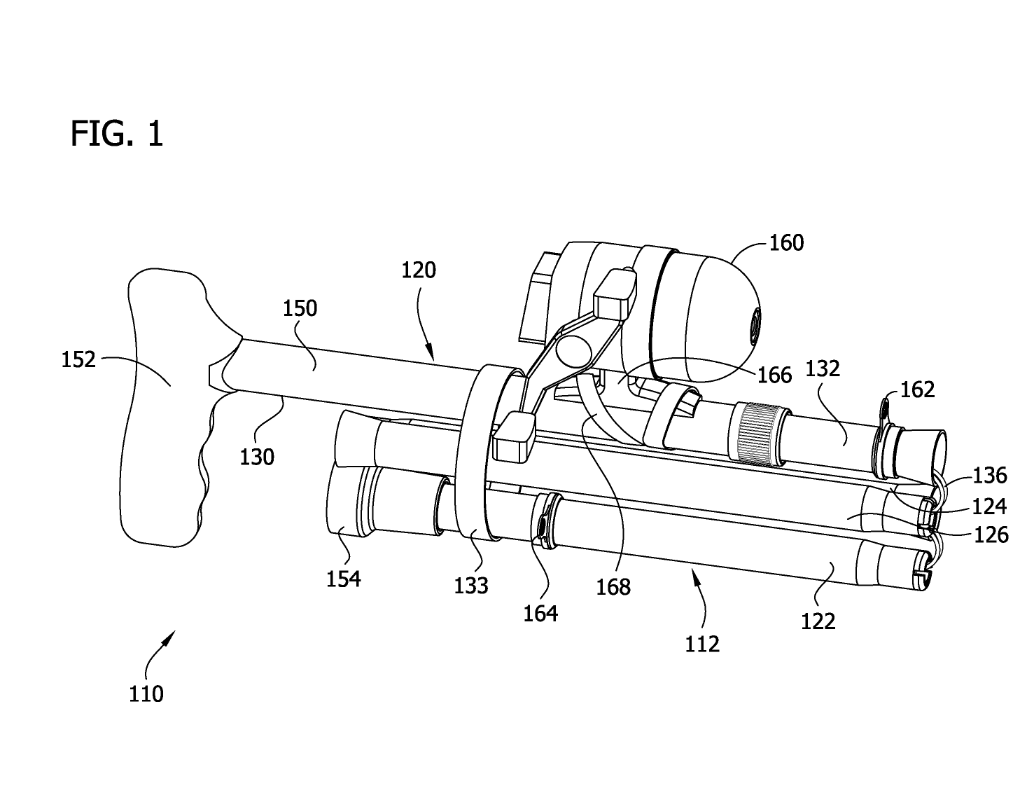

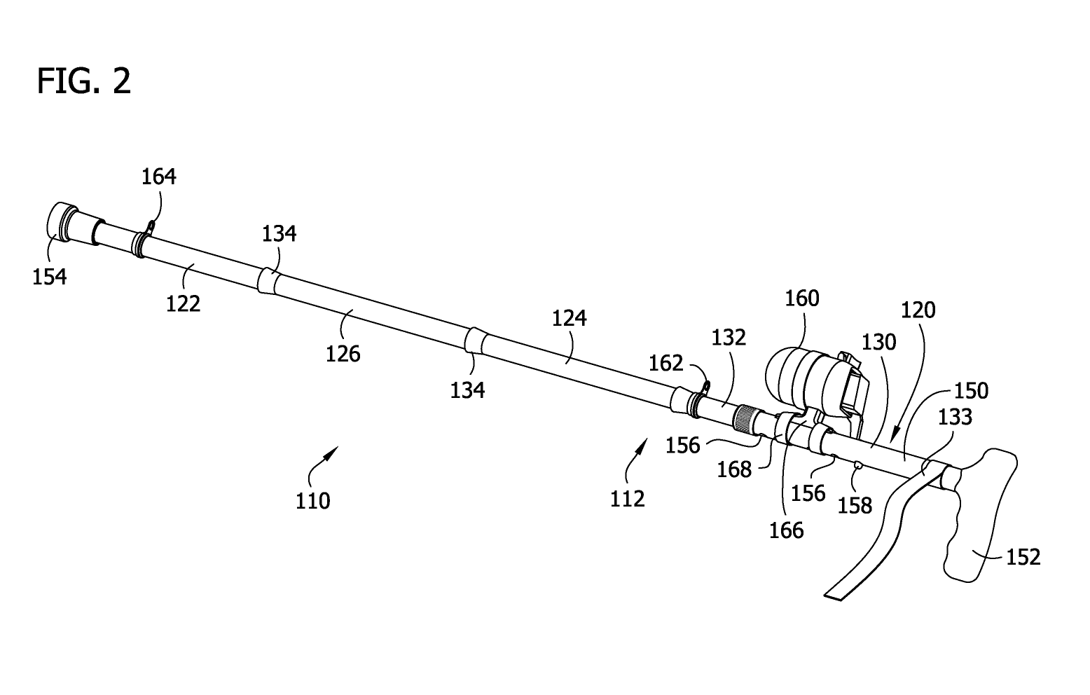

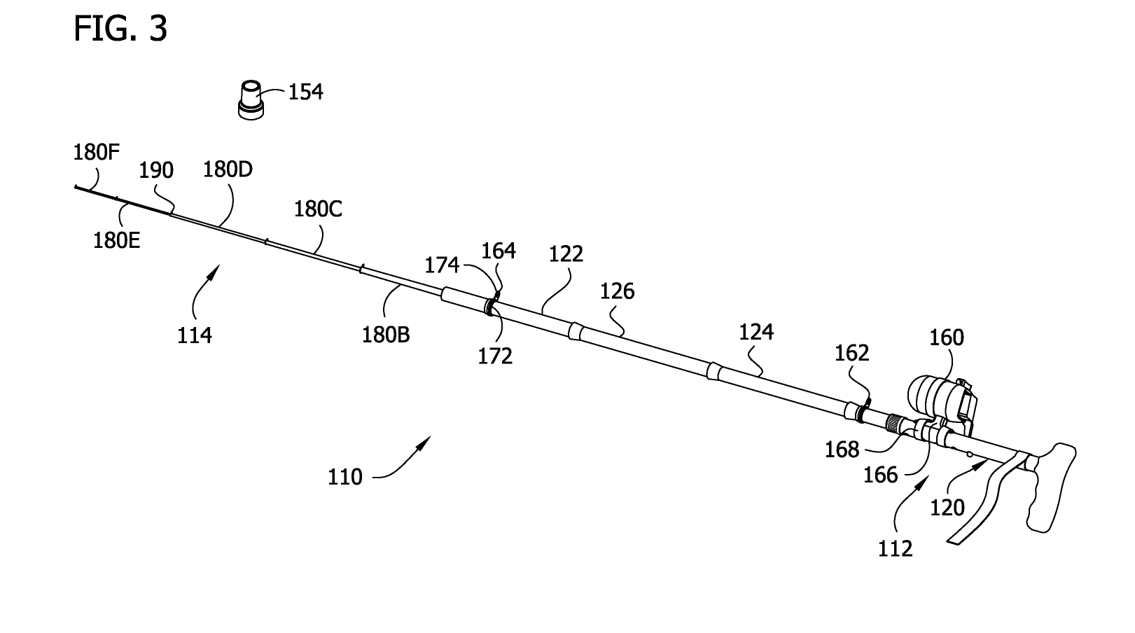

Referring to FIGS. 1-3, a dual-purpose apparatus that functions as a walking cane and a fishing rod is generally indicated at reference number 110. The apparatus 110 includes a foldable base assembly 112, which folds between a collapsed position (FIG. 1) and an elongate position (FIGS. 2 and 3). The apparatus 110 also includes a telescoping end assembly 114, which telescopes from a collapsed position (FIGS. 1 and 2) to an extended position (FIG. 3). As will be appreciated, the apparatus 110 may be selectively configured to be stowed away (FIG. 1) or to function as a walking cane (FIG. 2) or fishing rod (FIG. 3). The apparatus combines the capabilities of a walking cane and fishing rod so that a walking cane user can carry one apparatus to a fishing hole instead of two.

Referring to FIGS. 1 and 2, the base assembly 112 includes a proximal handle assembly 120, a distal tubular member 122, and two intermediate tubular members 124, 126. Other numbers of intermediate tubular members may be used without departing from the scope of the invention. The distal handle assembly 120 comprises a handle member 130 and a shaft member 132. As will be discussed in further detail below, the handle member 130 and shaft member 132 of the handle assembly 120 are selectively adjustable to adjust the length of the cane. When the handle member 130 and shaft member 132 are attached, the proximal handle assembly 120 functions as a proximal tubular member of the base assembly 112. The handle assembly 120 and tubular members 122, 124, 126 of the base assembly 112 are selectively foldable between a collapsed position (FIG. 1) in which the tubular members are arranged side-by-side with one another and an elongate position in which the tubular members are arranged end-to-end (FIG. 3) to form the shaft of a walking cane. A strap 133 may be used to secure the base assembly in the collapsed position. In the illustrated embodiment, the strap 133 comprises hook and loop fasteners. The strap 133 extends around the handle assembly 120 and tubular members 122, 124, 126 to secure the base assembly 112 in the collapsed position. Other ways of securing the base assembly 112 in the collapsed position may also be used without departing from the scope of the invention. For example, it is contemplated that a stretchable sleeve may be positioned around the handle assembly 120 and tubular members 122, 124, 126 to secure the base assembly 112 in the collapsed position.

When the base assembly 112 is unfolded into the elongated position, the shaft of the cane includes connections 134 between the handle assembly 120 and tubular members 122, 124, 126. The handle assembly 120 has a distal opening adjacent the distal end thereof, and each of the intermediate tubular members 124, 126 has a distal opening adjacent the distal ends thereof. When the base assembly 112 is folded to the elongated position, a proximal end portion of the intermediate tubular member 124 is received in the distal opening of the handle assembly 120 to form a connection 134. Likewise, proximal end portions of the intermediate tubular member 126 and distal tubular member 128 are each, respectively, received in the distal openings of the adjacent, proximal tubular member to form connections 134. The connections 134 inhibit the base assembly 120 from unfolding from the elongated position. Other types of connections between tubular members may also be used without departing from the scope of the invention.

The base assembly 120 also includes an elastic cord 136 that inhibits the base assembly from unfolding from the elongated position. One end of the elastic cord 136 is secured to the handle assembly 120 and the other end is secured to the distal tubular member 122. The elastic cord 134 extends internally from the handle assembly 120 through each of the intermediate tubular members 124, 126, to the distal tubular member 122. When the base assembly 112 is folded into the elongated position, the cord 136 is stretched in tension between the handle assembly 120 and proximal tubular member 122 so that the cord pulls the tubular members 120, 122, 124, 126 inward along the longitudinal axis of the shaft of the cane.

The handle assembly 120 is selectively adjustable so that users of different heights can use the apparatus 110 as a cane. The handle member 130 has an elongate tubular portion 150 and a handle portion 152 extending transverse to the tubular portion. The handle portion is adapted to be grasped by a user when the base assembly 112 is used as a cane. In the illustrated embodiment, the handle portion 152 is removable and may be replaced with other types of handles to suit a user's preferences. A rubberized end cap 154 is positioned over the open distal end of the distal tubular member 122. When the apparatus is used as a cane, the rubberized end cap 154 provides a high friction contact point between the base assembly 112 and the ground. With the rubberized end cap 154 positioned in contact with the ground, the user may grasp the handle portion 152 of the handle member 130 and lean against the cane for support. A plurality of adjustment holes 156 are spaced apart along the length of the tubular portion 140 of the handle member 130. The shaft member 132 is received in an open proximal end of the tubular portion 150 of the handle member 130. The shaft member 132 includes a selectively depressable projection 158 sized to fit in the adjustment holes 156. When the projection 158 is depressed, the handle member 152 may slide along the length of the shaft member 150. The projection 158 is released to extend into the adjustment hole 156 corresponding with the desired height for the cane.

In addition to the features that enable the base assembly 112 to be used as a walking cane as shown in FIG. 2, the base assembly 112 includes features that enable the use of the apparatus 110 as a fishing rod. The base assembly 112 includes a fishing reel 160 mounted on the handle member 130 and two line guides 162, 164 mounted, respectively, on the shaft member 132 and the distal tubular member 122. In the illustrated embodiment, the reel 160 is permanently affixed to the handle member 130. But it will be understood that the reel 160 may be removably attached to the base assembly 112 without departing from the scope of the invention. In the illustrated embodiment, a high strength adhesive tape secures the reel 160 to the handle member 130. A strap 168 and a pair of zip ties (which are not shown because they are concealed by the strap) extend around the base 166 of the reel 160 and handle member 130 to further secure the reel to the handle member. In an alternative embodiment, the reel 160 is mounted on the handle assembly using a mounting bracket and/or other mechanical fasteners.

The illustrated reel 160 is a spin caster reel. Other types of reels may also be used without departing from the scope of the invention. In the illustrated embodiment, each of the line guides 162, 164 are permanently affixed to the base assembly 112. The line guides may also be removably attached to the base assembly 112 without departing from the scope of the invention. Each line guide 162, 164 includes a mounting ring 172 and a guide ring 174. The mounting ring 172 of the line guide 162 extends around the shaft member 132 adjacent the open distal end thereof, and the mounting ring of the line guide 162 extends around the distal tubular member 122 adjacent the open distal end thereof. A high strength adhesive affixes the mounting rings 172 to the base assembly 112. When the apparatus 110 is to be used as a fishing rod, fishing line from the reel 160 extends through the openings in the guide rings 174 to prevent the line from becoming entangled along the length of the base assembly 112.

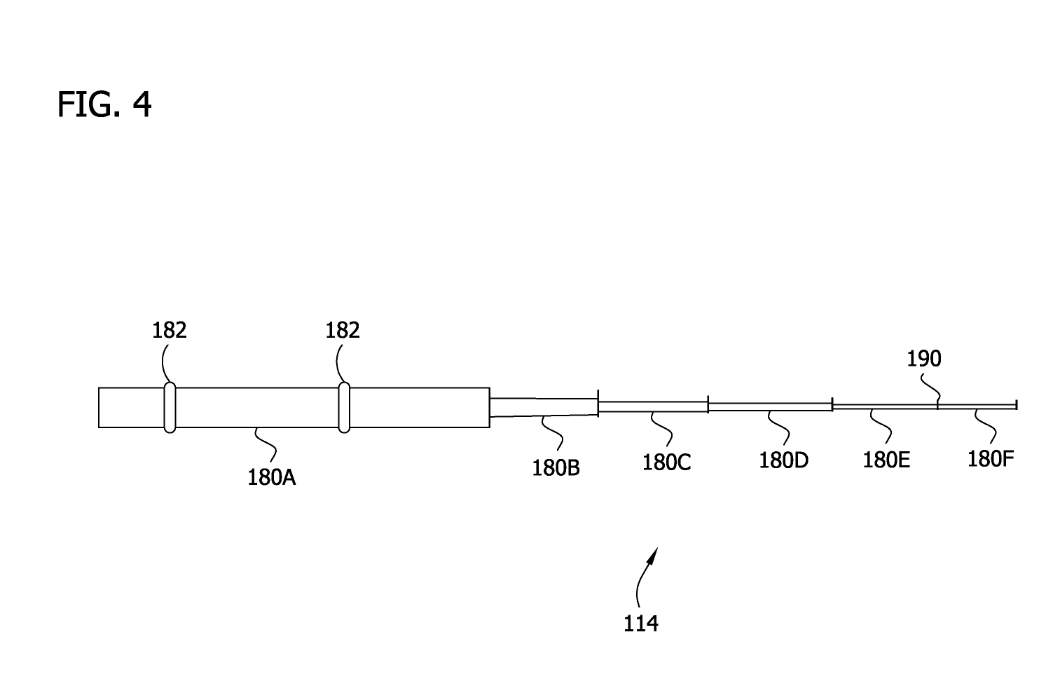

The telescoping end assembly 114 is stored in the distal tubular member 122 in the collapsed position and can be extended to the elongate position after the end cap 154 is removed. Referring to FIG. 4, the telescoping end section comprises six of tubular members 180A-180F arranged concentrically for telescoping between the collapsed position and the elongate position. It will be understood that the telescoping end section could have other numbers of tubular members without departing from the scope of the invention. Each of the tubular members 180A-180E, with the exception of the distal-most tubular member 180F, has an interior passage (not shown) that has a diameter. The proximal-most one of the tubular members 180A has the interior passage having a diameter sized to receive the adjacent tubular member 180B therein. Likewise each of the tubular members 180B-180E has an interior passage having a diameter sized to receive the respective adjacent, distal tubular member 180C-180F therein. From the collapsed position, each of the tubular members 180B-180F slide distally through the respective adjacent, proximal tubular member 180A-180E to the elongate position. Preferably, when the telescoping end assembly reaches the elongate position, proximal end portions of the tubular members 180B-180F are received in and frictionally engage distal end portions of the respective adjacent, proximal tubular members 180A-180E to inhibit the end assembly from collapsing when the apparatus 110 is used as a fishing rod.

The proximal-most tubular member 180A is installed in the open distal end of the distal tubular member 122 to secure the end assembly 114 to the base assembly 116. As shown in FIG. 4, two O-rings 182 and a nut (not shown) are secured to the proximal tubular member 180A and the proximal tubular member is inserted into the open distal end of the distal tubular member 122. With the proximal tubular member 180A inserted into the open distal end of the distal tubular member 122, the distal tubular member is crimped against a base section of the nut to secure the proximal tubular member 122 in the distal opening and thereby secure the telescoping end assembly 114 to the base assembly 112. Additionally or in the alternative, an adhesive can be used to secure the proximal tubular member 180A to the distal tubular member 122. In the illustrated embodiment, the tubular members 180A-180F of the end assembly 114 are positioned within the distal tubular member 122 of the base assembly 114 when the end assembly is collapsed into the collapsed position. As a result, the end cap 154 can be positioned over the open distal end of the distal tubular member 122 to retain the end assembly 114 within the distal tubular member in the collapsed position. Thus, the telescoping end assembly 114 may be stowed away in the collapsed position when the apparatus 110 is used as a walking cane.

As shown in FIG. 3, the telescoping end assembly 114 may also be extended when the apparatus 110 is used as a fishing rod. Each of the tubular members 180B-180E comprises a fishing line guide 190. When the end assembly 114 is positioned in the elongate position, fishing line is threaded through the line guides 162, 164 of the base assembly 114 and threaded further through the line guides 190 of the end assembly 114. When the fishing line is threaded through each of the line guides 162, 164, including the line guide on the distal tubular member 180F, bait may be tied onto the free end of the line, and the apparatus 110 may be used for fishing.

In one method of making the apparatus 110, a manufacturer secures the proximal tubular member 180A of the telescoping end assembly 114 in the open distal end of the distal tubular member 122 of the base assembly 112. To secure the proximal tubular member 180A to the distal tubular member 122, the manufacturer secures at least one O-ring 182 to the proximal tubular member and secures a nut (not shown) to the proximal tubular member. Then, the manufacturer inserts the proximal tubular member 180A into the open distal end of the distal tubular member 122 and crimps the distal tubular member to the nut. The manufacturer further secures the reel 160 to the handle member 130 of the base assembly 112.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A collapsible fishing rod and pedestrian support apparatus comprising:
a base assembly comprising a plurality of tubular members foldably attached to one another for folding between a collapsed position in which the tubular members are arranged side-by-side and an elongate position in which the tubular members are arranged end-to-end, the plurality of tubular members of the base assembly comprising at least a proximal and a distal tubular member, the proximal tubular member of the base assembly comprising a proximal handle portion, the distal tubular member of the base assembly comprising an open distal end;
a telescoping end assembly comprising a plurality of tubular members arranged concentrically for telescoping between a collapsed position in which distal ends of each of the tubular members are arranged generally adjacent one another and an elongate position in which the tubular members are arranged end-to-end, the plurality of tubular members of the telescoping end assembly comprising at least a proximal and a distal tubular member, the proximal tubular member of the telescoping end assembly being secured in the open distal end of the distal tubular member of the base assembly such that the distal tubular member of the telescoping end assembly extends distally away from the base in the elongate position; and
a reel secured to the base assembly.

2. The apparatus of claim 1 further comprising an elastic cord secured at one end in the proximal tubular member of the base assembly and at another end in the distal tubular member of the base assembly and extending through the plurality of tubular members of the base assembly.

3. The apparatus of claim 2 wherein the base assembly further comprises at least one connection at which respective ends of two of the plurality of tubular members are secured to one another in the elongate position such that one of the respective ends is received in an opening of another of the respective ends.

4. The apparatus of claim 3 wherein the base assembly comprises a plurality of said connections.

5. The apparatus of claim 1 wherein the telescoping end assembly is positioned generally within the open distal end of the distal tubular member of the base assembly when the telescoping end assembly is in the collapsed position.

6. The apparatus of claim 5 further comprising an end cap securable to the open distal end of the distal tubular member of the base assembly when the telescoping end assembly is in the collapsed position.

7. The apparatus of claim 6 wherein the end cap is rubberized.

8. The apparatus of claim 1 wherein the proximal handle portion of the proximal tubular member of the base assembly is oriented transverse to the others of the tubular members of the base assembly in the elongate position.

9. The apparatus of claim 1 wherein the telescoping end assembly further comprises a line guide secured to the distal end of the distal tubular member.

10. The apparatus of claim 1 wherein the telescoping end assembly further comprises a plurality of line guides secured to the distal ends of a plurality of the tubular members.

11. The apparatus of claim 1 wherein the telescoping end assembly has a length in the collapsed position that is less than or equal to the length of the proximal tubular member of the base assembly.

12. The apparatus of claim 1 further comprising a strap securable about the plurality of tubular members of the base assembly in the collapsed position.

13. The apparatus of claim 1 further comprising a base assembly line guide secured to a tubular member of the base assembly.

14. The apparatus of claim 13 wherein the base assembly line guide comprises first and second rings, the first ring extending around a tubular member of the base assembly and securing the base assembly line guide thereto, and the second ring being sized to receive a fishing line.

15. The apparatus of claim 1 wherein the reel is secured to the proximal tubular member of the base assembly.

16. The apparatus of claim 1 wherein the apparatus is configured to be used as a walking cane when the base assembly is in the elongate position and the telescoping end assembly is in the collapsed position.

17. A method of making a collapsible fishing rod and pedestrian support apparatus, the method comprising:
securing a proximal tubular member of a telescoping end assembly comprising a plurality of tubular members arranged concentrically for telescoping between a collapsed position in which distal ends of each of the tubular members are arranged generally adjacent one another and an elongate position in which the tubular members of the telescoping end assembly are arranged end-to-end in an open distal end of a distal tubular member of a base assembly comprising a plurality of tubular members foldably attached to one another for folding between a collapsed position in which the tubular members are arranged side-by-side and an elongate position in which the tubular members are arranged end-to-end, wherein the plurality of tubular members of the base assembly comprises a proximal tubular member comprising a handle portion; and
securing a reel to the proximal tubular member of the base assembly.

18. The method of claim 17 further comprising securing an O-ring to the proximal tubular member of the telescoping end assembly.

19. The method of claim 18 further comprising securing a nut to the proximal tubular member of the telescoping end assembly.

20. The method of claim 19 wherein said securing the proximal tubular member of the telescoping end assembly comprises crimping the distal tubular member of the base assembly against the nut.
